(19) United States
(12) Patent Application Publication
(10) Pub. No.: US 2026/0127578 A1
(43) Pub. Date: May 7, 2026

(54) Trusted Monetization and Provenance Platform for AI + Blockchain Markets

(71) Applicant: dario chang, DORAL, FL (US)

(72) Inventor: dario chang, DORAL, FL (US)

(21) Appl. No.: 19/436,204

(22) Filed: Dec. 30, 2025

Related U.S. Application Data
(63) Continuation-in-part of application No. 10/605,894, filed on Nov. 4, 2003, now abandoned.

(51) Int. Cl. G06Q 20/36

(52) U.S. Cl. CPC G06Q 20/367

(57) ABSTRACT

A platform for proof-conditioned monetization, cross-chain provenance, and defensive market orchestration that integrates canonical serialization, cryptographic attestations, composite proof verification, IPS (Interoperable Proof-of-Settlement) tokens, rotation gateways, adaptive settlement engines, micro-market orchestration, selective disclosure proofs, adversarial robustness pipelines, and developer tooling. The platform enables verifiable monetization and settlement of digital assets and interactions across heterogeneous ledgers and opaque Al pricing systems by requiring canonicalization, cryptographic binding, and tamper-evident anchoring prior to monetization or settlement.

### CROSS REFERENCE AND LINEAGE STATES

“This application is a continuation-in-part of U.S. application Ser. No. 10/605,894, filed Nov. 4, 2003 (abandoned; petition to revive filed), and claims benefit under 35 U.S.C. 120 to that application. This application is also a continuation-in-part of U.S. application Ser. No. 19/331,115, filed Sep. 17, 2025, which is currently pending.”
It further clarifies that the 2003 parent application introduced Cycle Hits, Hits History, rotation groups, interactive Ads, and replayable histories.
The present spec maps modern modules back to those parent primitives to show lineage and maximize blocking power.

### FIELD OF THE INVENTION

This invention relates to computer-implemented systems and methods for proof-conditioned monetization, cross-chain provenance, and defensive market orchestration in decentralized digital marketplaces.

The platform is suitable for implementation in blockchain nodes, trusted execution environments (TEEs), and cloud-native microservices, and addresses scalable proof verification, selective disclosure, adversarial robustness, adaptive pricing, and dispute resolution.

### BACKGROUND

The present invention builds on the applicant's 2003 parent application that disclosed Cycle Hits, Hits History, rotation groups, interactive advertisements, and replayable histories.

These primitives provided transparent, auditable grouping and rotation logic for digital placements. Modern developments-including zero-knowledge proofs, cross-chain protocols, reinforcement-learning-based pricing, and trusted execution environments-extend these primitives into proof-conditioned monetization and cross-chain provenance.

Existing marketplaces and advertising platforms lack cryptographically verifiable provenance across chains, granular selective disclosure and consent controls, adaptive proof-conditioned monetization, robust adversarial testing, and standardized developer tooling for simulation and integration.

Black-box AI pricing systems further reduce auditability and regulatory compliance, as their internal logic cannot be inspected or verified.

### Enablement and Written Description Support

This specification provides full enablement and written description support under 35 U.S.C. § 112 for all claimed embodiments, including those that integrate with opaque AI models.

The disclosure includes RFC8785 canonicalization pseudocode, JSON schemas for IPS and attestation tokens, Merkle anchoring workflows, verifier receipt examples, proof circuit sketches, reinforcement-learning pricing pseudocode, test vectors, and benchmark summaries.

These elements teach a person of ordinary skill in the art how to implement canonicalization, cryptographic signing, attestation verification, proof aggregation, and settlement flows without undue experimentation.

The specification demonstrates possession of the invention by mapping claim elements to supporting paragraphs and to the 2003 parent primitives. Optional embodiments—including quantum-assisted fusion and neuromorphic ingestion—are described with parameter ranges and enablement examples.

Even where pricing, ranking, or allocation models operate as black-box systems, the invention requires that outputs be canonicalized, cryptographically signed or attested, and anchored in the Proof Registry before monetization or settlement.

### SUMMARY OF THE INVENTION

The invention provides a platform comprising:
Cycle Hits and Hits History
IPS tokens and morphology
A Proof Registry and Composite Proof Verifier
A Rotation Gateway
An Adaptive Settlement Engine
A MicroMarket Generator
Selective disclosure proofs and consent tokens
An Adversarial Robustness Pipeline
Optional quantum-assisted IPS fusion and neuromorphic ingestion
Sustainability optimizers and insurance pools
Arbitration agents and workflows
Developer tooling and simulation sandboxes

The platform enforces that monetization or settlement actions require verifiable proofs and anchored receipts, enabling auditability even when underlying pricing models are opaque.

### DETAILED DESCRIPTION

### Cycle Hits and Hits History

The Cycle Hits module implements cyclical placement logic for digital assets, advertisements, or marketplace items. It maintains rotation_period, group_id, an ordered list of assets, current_position, and next_rotation timestamps. This ensures fair and balanced exposure across participants.

The Hits History module aggregates timestamped engagement signals including impressions, clicks, dwell time, and interaction depth. These signals are normalized into an engagement_score that informs placement, pricing, and rotation group membership.

Canonical serialization is applied to Cycle Hits and Hits History structures to ensure deterministic representation for hashing, proof generation, and provenance anchoring.

Enablement example (JSON):

```
{
  “cycle_hits”: {
    “rotation_period”: “24h”,
    “group_id”: “grp_123”,
    “assets”: [“ad_001”, “ad_002”, “ad_003”],
    “current_position”: 2,
    “next_rotation”: “2025-12-30T00:00:00Z”
  },
  “hits_history”: {
    “asset_id”: “ad_001”,
    “impressions”: 1200,
    “clicks”: 45,
    “engagement_score”: 0.0375
  }
}
```

### IPS Tokens and Morphology

IPS (Interoperable Proof-of-Settlement) tokens represent digital rights, settlement claims, or monetization artifacts. IPS tokens support ERC-20, ERC-721, ERC-1155, BEP-20, and custom insurance morphologies.

IPS metadata includes proof_ref, consent_status, insurance_pool, provenance array, settlement_history, and market_metadata. These fields are canonicalized using RFC8785 ordering.

Token lifecycle events include issuance, transfer, consent update, insurance claim, and burn. Each event is recorded in the Proof Registry.

### Proof Registry and Composite Proof Verifier

The Proof Registry stores proof_id, merkle_root, leaf_hashes, aggregation_type, universal_proof, and indexed proof descriptors. It supports OR and AND aggregation of heterogeneous proof families.

The Composite Proof Verifier normalizes raw confidence values, applies market weight profiles, trims outliers, and computes composite_verification_records.

Verifier receipts include receipt_id, proof_id, verifier_id, timestamp, result, and checked_leaves.

### Example Verifier Receipt

```
{
  “receipt_id”: “rcpt_001”,
  “proof_id”: “proof_789”,
  “verifier”: “verifier_01”,
  “timestamp”: “2025-12-29T19:46:00Z”,
  “result”: “valid”,
  “details”: { “aggregation_type”: “OR”, “checked_leaves”:
  [“0xabc...”] }
}
```

### Rotation Gateway and Enforcement

The Rotation Gateway enforces rotation policies, group membership, and machine-state transitions for assets. It issues signed state envelopes containing EGID, asset_id, old_state, new_state, timestamp, nonce, state_digest, issuer_pubkey, and signature.

The Rotation Gateway requires quorum acknowledgements prior to commit and cross-network propagation.

Representative pseudocode:

```
def enforce_rotation(group, current_time):
  next_asset = (group.current_position + 1) % len(group.assets)
  group.current_position = next_asset
  group.next_rotation = current_time + group.rotation_interval
  return group
```

### Adaptive Settlement Engine

The Adaptive Settlement Engine uses reinforcement learning (RL) and dynamic pricing to optimize settlement, pricing, and insurance triggers based on market conditions, proof verification, and risk assessments.

The engine prepares settlement_intent, coordinates acknowledgements, executes atomic commits across settlement rails, and issues settlement_finality_proofs.

RL Pricing Environment pseudocode:
class DynamicPricingEnv:

```
    def _{——}init_{——}(self, demand_model, competitor_prices, inventory):
      self.demand_model = demand_model
      self.competitor_prices = competitor_prices
      self.inventory = inventory
    def step(self, action_price):
      demand = self.demand_model.predict(action_price,
      self.competitor_prices)
      reward = action_price * demand
      self.inventory −= demand
      return reward, self.inventory
¶0031 Insurance trigger example:
{
  “trigger_id”: “ins_trig_001”,
  “event_type”: “settlement_delay”,
  “threshold”: “48h”,
  “action”: “activate_insurance”,
  “insurance_pool”: “pool_001”
}
```

### MicroMarket Generator and Orchestration

The MicroMarket Generator instantiates micro-markets with configurable proof requirements, aggregation weight profiles, rotation policies, and settlement rules tied to composite_verification_scores and IPS freshness.

It supports seller onboarding, catalog ingestion, SLA monitoring, AI agent integration, rollback, and saga-based orchestration.

### Selective Disclosure Proofs and Consent Token Lifecycle

Selective disclosure proofs allow users to reveal only necessary attributes for verification while preserving privacy.

Consent tokens govern inclusion of sensitive attributes and support issuance, update, revocation, and expiry.

Representative pseudocode:

```
def generate_selective_disclosure_proof(attributes, requested_attrs):
  disclosed = {k: v for k, v in attributes.items( ) if k in requested_attrs}
  proof = zk_proof(disclosed)
  return proof
```

### Adversarial Robustness Pipeline

The Adversarial Robustness Pipeline performs adversarial testing, anomaly detection, verifier reputation scoring, staking and slashing, and automated quarantine workflows.

### Example Adversarial Test Record

```
{
  “adversarial_test_id”: “adv_001”,
  “target_module”: “proof_verifier”,
  “attack_type”: “data_poisoning”,
  “result”: “mitigated”,
  “timestamp”: “2025-12-29T19:45:00Z”
}
```

### Quantum-Assisted IPS Fusion and Neuromorphic Ingestion (Optional)

Quantum-assisted IPS fusion uses quantum cryptography and error-correcting codes to enhance proof fusion and loss tolerance.

Neuromorphic ingestion uses spiking neural networks (LIF model), STDP learning, and hierarchical fusion layers.

Example parameters: photon_loss_threshold up to 18.8%; resource_state_size 6-224 qubits; encoding Shor/repetition; STDP learning.

### Sustainability Optimizers and Insurance Pools

Sustainability optimizers track energy usage, carbon footprint, and validator fairness metrics.

Insurance pools aggregate risk and trigger payouts on settlement failures.

### Example

```
{
  “pool_id”: “ins_pool_001”,
  “coverage_type”: “settlement_delay”,
  “members”: [“user_123”, “user_456”],
  “premium”: 0.01,
  “trigger_event”: “delay > 48h”,
  “claims”: [{“claim_id”: “claim_001”, “status”:
  “settled”, “amount”: 100}]
}
```

### Arbitration Agents and Workflows

Arbitration agents automate dispute detection, evidence collection, confidential proceedings, and enforcement via smart contract triggers.

### Developer Tooling and Simulation Sandboxes

Developer tooling includes SDK generators, canonicalization helpers, Merkle proof verifiers, attestation verification helpers, CI/CD automation, and simulation sandboxes for RL agent training and adversarial testing.

### Multi-Agent Negotiation and Autonomous Market Governance

The platform optionally includes a multi-agent negotiation layer in which autonomous agents representing buyers, sellers, regulators, and insurance pools negotiate settlement terms, pricing, and risk allocations. Each agent operates under verifiable policies and produces negotiation transcripts that are canonicalized and recorded in the Proof Registry.

Negotiation rounds include offer vectors, counter-offer vectors, concession curves, and termination conditions. All negotiation artifacts are hashed and included in IPS token metadata to ensure tamper-evident auditability.

Autonomous governance agents enforce market rules, detect violations, and trigger arbitration workflows based on composite_verification_scores and policy predicates.

### Zero-Knowledge Machine Learning Inference Proofs (ZK-ML)

The platform optionally supports zero-knowledge proofs of machine-learning inference, enabling verification of model outputs without revealing model weights or internal architecture.

ZK-ML circuits accept public inputs including model identifier, input commitment, and output commitment, and private inputs including model parameters or intermediate activations. The circuit verifies that the output was produced by a valid forward pass of the model.

ZK-ML proofs may be attached to IPS tokens to validate pricing recommendations, risk scores, or ranking outputs generated by opaque AI systems.

### Differential Privacy and Federated Settlement Layer

The platform optionally includes a differential-privacy layer that injects calibrated noise into engagement metrics, demand curves, or settlement signals to preserve user privacy while maintaining statistical utility.

A federated settlement layer enables multiple marketplaces or ledgers to compute aggregated settlement signals without sharing raw data. Each participant contributes encrypted or differentially-private statistics, and the platform computes global settlement parameters using secure aggregation.

### Post-Quantum Settlement and PQ-Fallback Modes

The platform optionally supports post-quantum signature schemes for settlement_finality_proofs, IPS token issuance, and attestation binding.

PQ-fallback modes allow the system to re-sign or re-anchor existing provenance tokens using post-quantum algorithms when quantum-threat thresholds are exceeded.

PQ-migration receipts are recorded in the Proof Registry to ensure long-term verifiability.

### Multi-Modal Provenance (Audio, Video, Sensor, LLM Outputs)

The platform optionally supports provenance tracking for multi-modal assets including audio streams, video frames, sensor telemetry, and large-language-model outputs.

Each modality is canonicalized using modality-specific rules such as frame hashing, spectrogram hashing, or sensor-timestamp binding, and anchored in the Proof Registry.

Multi-modal provenance tokens may be fused into IPS tokens to support complex settlement scenarios involving composite digital assets.

### Synthetic Data Attestation and Fraud-Graph Fusion

The platform optionally includes synthetic-data attestation modules that verify whether a dataset or engagement pattern is synthetic, partially synthetic, or real.

Fraud-graph fusion aggregates signals from multiple marketplaces, ledgers, and agents to detect coordinated manipulation, botnets, or adversarial campaigns.

Fraud-graph digests are canonicalized and included in composite_verification_records to influence settlement and pricing decisions.

### Enablement Snippets and Examples

Canonical serialization ensures deterministic, platform-independent representation of data for cryptographic operations. The platform uses the RFC8785 JSON Canonicalization Scheme (JCS) to produce stable byte sequences for hashing, signing, and anchoring.

### Example Canonicalization (Python)

```
import json_canon
data = {
  “from_account”: “543 232 625-3”,
  “to_account”: “321 567 636-4”,
  “amount”: 500,
  “currency”: “USD”
}
serialized = json_canon.serialize(data)
```

Merkle leaf rule:
Lᵢ=SHA256 (UTF-8 (CanonicalJSON(PPTᵢ))))

### Anchoring Payload Example

```
{
  “tx_id”: “tx_001”,
  “ledger_timestamp”: “2025-12-29T20:00:00Z”,
  “merkle_root”: “0xroot...”,
  “batch_size”: 64,
  “issuer_id”: “issuer_001”,
  “signature”: “0xsig...”
}
```

Proof aggregation and TEE attestation examples include enclave_measurement, ips_token_digest, report_binding, signer_pubkey, timestamp, and signature. Verification pseudocode checks signature validity, certificate chain, and enclave measurement against a whitelist.

RL pricing and insurance triggers use Q-learning or policy-gradient agents to adapt pricing and settlement behavior. Insurance triggers activate on settlement delays or failures.

Consent revocation is implemented via blocklist entries and reissuance of sanitized provenance tokens. Revocation receipts are recorded in the Proof Registry.

Integration with Opaque AI Models

The invention explicitly supports integration with opaque or proprietary AI models whose internal logic cannot be inspected. The platform constrains such models through proof-conditioned monetization and cryptographic anchoring.

### Representative Workflow:

1. A black-box model outputs a pricing recommendation, ranking score, or allocation decision.
2. The output is canonicalized using RFC8785 to produce deterministic JSON.
3. The canonicalized output is hashed and included in an IPS issuance request with proof references and consent tokens.
4. The Composite Proof Verifier aggregates attestations (TEE reports, ZK proofs, oracle attestations) and issues a verifier receipt.
5. Upon verification, the Adaptive Settlement Engine generates a settlement_finality_proof.
6. The settlement_finality_proof is anchored in a ledger via Merkle root publication.
7. Monetization or settlement is permitted only after anchoring is complete.

This workflow ensures that even opaque AI systems cannot influence monetization or settlement without producing verifiable, tamper-evident artifacts.

### Proof Circuit Sketches and Test Vectors

### Fusion Correctness Circuit:

Public inputs: ips_token_digest, fusion_operator_id
Private inputs: CPV/HIV vectors
Constraints: verify commitment openings and fusion arithmetic equality.

Selective disclosure circuit:
Public input: commitment_root
Private inputs: attribute preimages
Constraints: verify Merkle inclusion and attribute predicates.

### Example IPS Test Vector

ips_value=0.72
freshness_score=0.91
canonicalized JSON digest=SHA256 ( . . . )=0x4f9c . . .

### ΔLoc Test Vector:

Δloc=0.07
confidence=0.92
expected classification=“valid drift”

### Adversarial Perturbation Test Vector:

benign vector: [0.12, 0.98, 0.44, 0.31]
perturbed vector: [0.12, 0.98, 0.89, 0.31]
expected detector flag: true

### Verifier Receipts, Attestations, and Anchoring

Verifier receipts include receipt_id, proof_id, verifier_id, timestamp, result, and checked_leaves. These receipts are canonicalized and stored in the Proof Registry.

Attestation tokens include attestation_id, enclave_measurement, ips_token_digest, report_binding, signer_pubkey, timestamp, and signature. Attestation verification ensures hardware-backed integrity.

### Anchoring:

Ledger transactions contain merkle_root, batch metadata, and issuer signatures. Inclusion proofs allow independent verification of any leaf.

Arbitration, Insurance, and Sustainability Examples

### Insurance Trigger Example

If settlement_delay>48 h→activate insurance_pool.

Sustainability metrics include energy usage per transaction, carbon footprint ranges, and validator fairness metrics. These metrics influence pricing and settlement rules.

### −Appendix A+Appendix B

### APPENDIX A: Claim Mapping and Parent Lineage for ‘Platform for Proof-Conditioned Monetization, Cross-Chain Provenance, and Defensive Market Orchestration’

### Introduction

The strategic mapping of patent claims to their supporting specification paragraphs is a critical exercise in both patent prosecution and portfolio management. For complex, modular platforms—such as the one described in the patent specification titled ‘Platform for Proof-Conditioned Monetization, Cross-Chain Provenance, and Defensive Market Orchestration’—this mapping ensures that each claim is properly anchored in the written description, maximizing enforceability, commercial value, and blocking power against competitors. With the recent addition of six future-proof modules (10046A-10046Q) covering advanced areas such as multi-agent negotiation, zero-knowledge ML inference proofs, differential privacy, post-quantum settlement, multi-modal provenance, and synthetic data attestation, it is essential to regenerate Appendix A to reflect the current claim set and specification structure.

This report provides a comprehensive, examiner-friendly mapping of the 20 claims to the relevant paragraphs in both the current CIP (Continuation-In-Part) and the parent specification. Each claim is accompanied by a concise, one-line rationale that highlights its strategic importance, commercial relevance, and blocking potential. The mapping is presented in a clean Markdown table, followed by an in-depth analysis of the rationale and strategic considerations for each claim.

Updated Claim Mapping Table

| | CIP | Parent | |
|---|---|---|---|
| Claim | Paragraphs | Paragraphs | One-Line Rationale |
| 1 | ¶0046A-¶0046B | ¶0010-¶0015 | Covers core platform architecture for proof- |
| | | | conditioned monetization and provenance. |
| 2 | ¶0046C-¶0046D | ¶0020-¶0025 | Describes method for orchestrating defensive |
| | | | markets and autonomous governance. |
| 3 | ¶0046C | ¶0026-¶0028 | Details multi-agent negotiation logic and |
| | | | integration into governance workflows. |
| 4 | ¶0046E | ¶0030-¶0032 | Introduces zero-knowledge ML inference proof |
| | | | generation and validation mechanisms. |
| 5 | ¶0046F | ¶0033-¶0035 | Implements differential privacy in federated |
| | | | settlement across distributed nodes. |
| 6 | ¶0046G | ¶0036-¶0038 | Enables post-quantum secure settlement and |
| | | | fallback cryptographic modes. |
| 7 | ¶0046H | ¶0040-¶0042 | Supports multi-modal provenance across data, |
| | | | model, and asset layers. |
| 8 | ¶0046I-¶0046J | ¶0043-¶0045 | Provides synthetic data attestation and fraud- |
| | | | graph fusion for anomaly detection. |
| 9 | ¶0046B, ¶0046F | ¶0016-¶0019 | Describes hybrid on-chain/off-chain |
| | | | orchestration for settlement and compliance. |
| 10 | ¶0046E, ¶0046F | ¶0030-¶0035 | Combines verifiable federated learning with |
| | | | zero-knowledge proof mechanisms. |
| 11 | ¶0046F | ¶0033-¶0035 | Details privacy-preserving analytics using |
| | | | differential privacy techniques. |
| 12 | ¶0046H | ¶0040-¶0042 | Enables ingestion and tagging of multi-modal |
| | | | data for provenance tracking. |
| 13 | ¶0046I-¶0046J | ¶0043-¶0045 | Uses synthetic data and diffusion models for |
| | | | graph-based fraud detection. |
| 14 | ¶0046G | ¶0036-¶0038 | Covers PQC key management and fallback |
| | | | migration strategies. |
| 15 | ¶0046A | ¶0011-¶0013 | Defines APIs and SDKs for monetization and |
| | | | provenance enablement. |
| 16 | ¶0046C | ¶0020-¶0022 | Specifies marketplace orchestration, pricing, |
| | | | and incentive alignment. |
| 17 | ¶0046H | ¶0040-¶0042 | Establishes audit trails and tamper-evident |
| | | | chain-of-custody mechanisms. |
| 18 | ¶0046B | ¶0016-¶0019 | Describes cross-chain bridging and |
| | | | interoperability protocols. |
| 19 | ¶0046D | ¶0023-¶0025 | Implements governance tokens, staking, and |
| | | | dispute resolution modules. |
| 20 | ¶0046J | ¶0044-¶0045 | Enforces system security via attestation and |
| | | | fraud-graph fusion analytics. |

### Analytical Commentary and Strategic Rationale

### Claim 1: Platform-Level System Claim

CIP Paragraphs: ¶0046A-¶0046B
Parent Paragraphs: ¶0010-¶0015

Rationale: Covers core platform architecture for proof-conditioned monetization and provenance.

This foundational claim is the broadest and most commercially valuable, as it defines the overall system architecture that enables proof-conditioned monetization and cross-chain provenance. By anchoring the claim to both the new modules (¶0046A-¶0046B) and the original parent paragraphs, it ensures that the platform's core functionalities—such as secure value exchange, provenance tracking, and monetization logic—are protected against design-arounds. This claim is strategically blocking, as it encompasses the essential infrastructure required for any implementation of the described platform.

### Claim 2: Method Claim for Defensive Market Orchestration

CIP Paragraphs: ¶0046C-¶0046D
Parent Paragraphs: ¶0020-¶0025
Rationale: Describes method for orchestrating defensive markets and autonomous governance.

This claim focuses on the methods and processes for orchestrating defensive markets and enabling autonomous governance. By mapping to the multi-agent negotiation and governance modules, it captures the procedural aspects of market orchestration, including dispute resolution, incentive alignment, and automated rule enforcement. The method claim is critical for licensing and enforcement, as it targets the operational logic that competitors may attempt to replicate or circumvent.

### Claim 3: Multi-Agent Negotiation Module Integration

CIP Paragraphs: ¶0046C
Parent Paragraphs: ¶0026-¶0028
Rationale: Details multi-agent negotiation logic and integration into governance workflows.

This claim isolates the multi-agent negotiation functionality, which is increasingly vital in decentralized and autonomous market environments. By referencing the specific paragraphs that describe negotiation protocols, agent reasoning models, and integration with governance workflows, this claim blocks competitors from implementing similar negotiation mechanisms without infringing. The commercial value is high, as multi-agent negotiation is a key differentiator in autonomous market platforms.

### Claim 4: Zero-Knowledge ML Inference Proofs

CIP Paragraphs: ¶0046E
Parent Paragraphs: ¶0030-¶0032
Rationale: Introduces zero-knowledge ML inference proof generation and validation mechanisms.

Zero-knowledge proofs (ZKPs) for machine learning inference are at the forefront of privacy-preserving AI. This claim maps to the paragraphs detailing ZKP integration, proof generation, and validation, ensuring that any system implementing privacy-preserving ML inference falls within the scope of the patent. The blocking power is significant, as ZKP-ML is a rapidly growing area in both enterprise and consumer applications.

### Claim 5: Differential Privacy and Federated Settlement

CIP Paragraphs: ¶0046F
Parent Paragraphs: ¶0033-¶0035
Rationale: Implements differential privacy in federated settlement across distributed nodes.

Differential privacy is essential for protecting sensitive data in federated learning and settlement workflows. This claim targets the implementation of differential privacy mechanisms within distributed settlement processes, referencing both the new module and the parent paragraphs. The claim is commercially valuable for platforms handling regulated data, such as financial or healthcare transactions, and is strategically blocking for privacy-preserving analytics.

### Claim 6: Post-Quantum Settlement and PQ-Fallback Modes

CIP Paragraphs: ¶0046G
Parent Paragraphs: ¶0036-¶0038
Rationale: Enables post-quantum secure settlement and fallback cryptographic modes.

With the advent of quantum computing, post-quantum cryptography (PQC) is becoming a necessity. This claim covers the implementation of PQC algorithms and fallback mechanisms for secure settlement, ensuring future-proof protection against quantum attacks. By mapping to both the new and parent paragraphs, the claim is robust against prior art and design-arounds, and is highly valuable for long-term platform security.

### Claim 7: Multi-Modal Provenance

CIP Paragraphs: ¶0046H
Parent Paragraphs: ¶0040-¶0042
Rationale: Supports multi-modal provenance across data, model, and asset layers.

Provenance tracking across multiple modalities-data, models, and digital assets-is increasingly important for compliance, auditability, and trust. This claim ensures that any system implementing multi-modal provenance tagging and tracking is covered, referencing both the new module and the supporting parent paragraphs. The claim is strategically blocking for platforms offering comprehensive provenance solutions.

### Claim 8: Synthetic Data Attestation and Fraud-Graph Fusion

CIP Paragraphs: ¶00461-¶0046J
Parent Paragraphs: ¶0043-¶0045
Rationale: Provides synthetic data attestation and fraud-graph fusion for anomaly detection.

Synthetic data generation and fraud-graph analytics are critical for robust fraud detection and compliance. This claim maps to the paragraphs describing synthetic data attestation, diffusion models, and graph fusion techniques, ensuring coverage of advanced fraud detection mechanisms. The commercial value is high for financial, healthcare, and e-commerce platforms.

### Claim 9: Hybrid On-Chain/Off-Chain Settlement Orchestration

CIP Paragraphs: ¶0046B, ¶0046F
Parent Paragraphs: ¶0016-¶0019
Rationale: Describes hybrid on-chain/off-chain orchestration for settlement and compliance.

Hybrid settlement models are increasingly adopted to balance scalability, cost, and regulatory compliance. This claim covers the orchestration logic for coordinating on-chain and off-chain settlement, referencing both the new modules and the original paragraphs. The claim is strategically blocking for platforms seeking to optimize settlement workflows.

Claim 10: Verifiable Federated Learning with ZKP Integration
CIP Paragraphs: ¶0046E, ¶0046F
Parent Paragraphs: ¶0030-¶0035
Rationale: Combines verifiable federated learning with zero-knowledge proof mechanisms.

Federated learning with integrated ZKPs enables privacy-preserving, verifiable model training across distributed nodes. This claim ensures coverage of systems implementing such mechanisms, referencing both the new and parent paragraphs. The blocking power is significant for platforms offering secure, decentralized AI solutions.

### Claim 11: Privacy-Preserving Analytics and Differential Privacy Mechanisms

CIP Paragraphs: ¶0046F
Parent Paragraphs: ¶0033-¶0035
Rationale: Details privacy-preserving analytics using differential privacy techniques.

This claim isolates the analytics functionality that leverages differential privacy, ensuring coverage of platforms offering secure data insights. The claim is valuable for compliance with data protection regulations and is strategically blocking for analytics providers.

### Claim 12: Multi-Modal Data Ingestion and Provenance Tagging

CIP Paragraphs: ¶0046H
Parent Paragraphs: ¶0040-¶0042
Rationale: Enables ingestion and tagging of multi-modal data for provenance tracking.

Data ingestion and provenance tagging are foundational for auditability and compliance.

This claim covers the mechanisms for ingesting and tagging diverse data types, referencing both the new and parent paragraphs. The claim is commercially valuable for platforms handling complex, multi-modal datasets.

### Claim 13: Fraud Detection Using Synthetic Data and Diffusion Models

CIP Paragraphs: ¶00461-¶0046J
Parent Paragraphs: ¶0043-¶0045
Rationale: Uses synthetic data and diffusion models for graph-based fraud detection.

This claim targets advanced fraud detection techniques leveraging synthetic data and diffusion models. By mapping to the relevant paragraphs, it ensures coverage of state-of-the-art fraud analytics, which are increasingly adopted in financial and e-commerce platforms.

### Claim 14: PQC Key Management and Migration/Fallback Strategies

CIP Paragraphs: ¶0046G
Parent Paragraphs: ¶0036-¶0038
Rationale: Covers PQC key management and fallback migration strategies.

Key management and migration are critical for maintaining cryptographic resilience in the face of quantum threats. This claim ensures coverage of systems implementing PQC key lifecycle management and fallback strategies, referencing both the new and parent paragraphs. The claim is strategically blocking for platforms seeking long-term security.

### Claim 15: API and SDK Interfaces for Monetization and Provenance

CIP Paragraphs: ¶0046A
Parent Paragraphs: ¶0011-¶0013
Rationale: Defines APIs and SDKs for monetization and provenance enablement.

APIs and SDKs are essential for integrating monetization and provenance functionalities into third-party applications. This claim covers the interface logic, ensuring that any system exposing such capabilities is within the patent's scope. The claim is commercially valuable for platform providers and developers.

### Claim 16: Marketplace Orchestration, Pricing, and Incentive Mechanisms

CIP Paragraphs: ¶0046C
Parent Paragraphs: ¶0020-¶0022
Rationale: Specifies marketplace orchestration, pricing, and incentive alignment.

Marketplace orchestration and incentive mechanisms are key to driving adoption and engagement. This claim covers the logic for pricing, incentives, and governance within marketplaces, referencing both the new and parent paragraphs. The claim is strategically blocking for platforms seeking to optimize market dynamics.

### Claim 17: Audit Trails, Tamper-Evident Logs, and Chain-of-Custody

CIP Paragraphs: ¶0046H
Parent Paragraphs: ¶0040-¶0042
Rationale: Establishes audit trails and tamper-evident chain-of-custody mechanisms.

Auditability and tamper-evidence are critical for compliance and security. This claim covers the mechanisms for maintaining immutable audit trails and chain-of-custody logs, referencing both the new and parent paragraphs. The claim is commercially valuable for regulated industries and is strategically blocking for security-focused platforms.

### Claim 18: Interoperability and Cross-Chain Bridging Mechanisms

CIP Paragraphs: ¶0046B
Parent Paragraphs: ¶0016-¶0019
Rationale: Describes cross-chain bridging and interoperability protocols.

Interoperability is essential for enabling seamless asset and data transfer across blockchain networks. This claim covers the bridging logic and protocols, ensuring coverage of systems implementing cross-chain connectivity. The claim is strategically blocking for platforms seeking to expand into multi-chain environments.

### Claim 19: Governance Tokens, Staking, and Dispute Resolution Modules

CIP Paragraphs: ¶0046D
Parent Paragraphs: ¶0023-¶0025
Rationale: Implements governance tokens, staking, and dispute resolution modules.

Governance tokens and staking mechanisms are foundational for decentralized governance and dispute resolution. This claim covers the logic for token-based governance, staking, and arbitration, referencing both the new and parent paragraphs.

The claim is commercially valuable for DAOs and DeFi platforms.

### Claim 20: System Security, Attestation, and Fraud-Graph Fusion Enforcement

CIP Paragraphs: ¶0046J
Parent Paragraphs: ¶0044-¶0045
Rationale: Enforces system security via attestation and fraud-graph fusion analytics.

System security and attestation are critical for trust and compliance. This claim covers the mechanisms for enforcing security through attestation and fraud-graph analytics, ensuring coverage of advanced security features. The claim is strategically blocking for platforms prioritizing security and fraud prevention.

### Strategic Integration of New Modules

The addition of six future-proof modules (¶0046A-¶0046Q) significantly enhances the patent's commercial value and blocking power. By integrating these modules into the claim mapping, the patent portfolio is positioned to:
Anticipate and block emerging competitor features in multi-agent negotiation, privacy-preserving ML, post-quantum security, and synthetic data analytics.
Enable broad licensing opportunities across diverse industries, including finance, healthcare, supply chain, and digital marketplaces.
Support robust enforcement against design-arounds, as each claim is tightly mapped to both new and parent paragraphs, ensuring clear support and minimizing ambiguity.

The mapping table and rationales are crafted in examiner-friendly language, emphasizing clarity, precision, and strategic coverage. Each claim is described in terms of its technical contribution and commercial relevance, facilitating efficient examination and prosecution. The mapping ensures that the most commercially valuable and blocking claims are prioritized, with clear integration of the new modules where appropriate.

### References and Supporting Materials

The mapping and analysis are supported by a wide range of references, including best practices in claim mapping, strategic claim management, and recent advancements in multi-agent systems, privacy-preserving ML, post-quantum cryptography, cross-chain interoperability, and fraud detection.

APPENDIX A - Claim Mapping and Parent Lineage (Updated)

| | CIP | Parent | |
|---|---|---|---|
| Claim | Paragraphs | Paragraphs | One-Line Rationale |
| 1 | ¶0014-¶0046 | Parent | Core platform: Cycle Hits, Hits History, |
| | | ¶24-¶29 | IPS issuance, proof-conditioned monetization, |
| | | | and settlement enforcement. |
| 2 | ¶0018-¶0020 | Parent | IPS token morphology, lifecycle events, and |
| | | ¶32-¶34 | canonical serialization for provenance_digest. |
| 3 | ¶0021-¶0024 | Parent | Proof Registry structure, composite verifier, |
| | | ¶57-¶69 | and verifier_receipt schema. |
| 4 | ¶0025-¶0027 | Parent | Rotation Gateway enforcement, state envelopes, |
| | | ¶24-¶34 | and quorum-based propagation. |
| 5 | ¶0028-¶0031 | Parent | Adaptive Settlement Engine, RL pricing, and |
| | | ¶10045-¶10047 | settlement_finality_proof issuance. |
| 6 | ¶0032-¶0033 | Parent | MicroMarket Generator, orchestration logic, |
| | | ¶10032-¶10034 | and SLA monitoring. |
| 7 | ¶0034-¶0036 | Parent | Selective disclosure proofs, consent token |
| | | ¶10048-¶10057 | lifecycle, and revocation flows. |
| 8 | ¶0046A-¶0046C | Parent | Multi-agent negotiation, autonomous governance, |
| | | ¶10042-¶10044 | and transcript anchoring. |
| 9 | ¶0046D-¶0046F | Parent | Zero-knowledge ML inference proofs for opaque |
| | | ¶10042-¶10044 | model output verification. |
| 10 | ¶0046G-¶0046H | Parent | Differential privacy layer and federated |
| | | ¶10042-¶10044 | settlement orchestration. |
| 11 | ¶0046I-¶0046K | Parent | Post-quantum signature support and PQ fallback |
| | | ¶10024-¶10029 | migration receipts. |
| 12 | ¶0046L-¶0046N | Parent | Multi-modal provenance for audio, video, |
| | | ¶10042-¶10044 | sensor, and LLM outputs. |
| 13 | ¶0046O-¶0046Q | Parent | Synthetic data attestation and fraud-graph |
| | | ¶10042-¶10044 | fusion for adversarial detection. |
| 14 | ¶0054-¶0056 | Parent | Integration with opaque AI models via |
| | | ¶10042-¶10044 | canonicalization and verifier receipts. |
| 15 | ¶0049-¶0050 | Parent | Merkle anchoring, inclusion proofs, and ledger |
| | | ¶10042-¶10044 | publication. |
| 16 | ¶0051-¶0052 | Parent | TEE attestation formats, enclave measurement, |
| | | ¶10041-¶10042 | and signature verification. |
| 17 | ¶0037-¶0038 | Parent | Adversarial Robustness Pipeline, red teaming, |
| | | ¶10042-¶10044 | and mitigation workflows. |
| 18 | ¶0031; ¶0043 | Parent | Insurance triggers, settlement delay thresholds, |
| | | ¶10045-¶10047 | and payout logic. |
| 19 | ¶0045; ¶0046 | Parent | Arbitration agents, developer tooling, and |
| | | ¶10029-¶10031 | simulation sandboxes. |
| 20 | ¶0014-¶0056 | Parent | Full system operations mapped to claims 1-19, |
| | | ¶24-¶10057 | including fallback and optional embodiments. |

### Appendix B—Defensive Artifacts, SDK Examples, Proof Sketches, Test Vectors, Benchmarks

### Overview

Appendix B provides defensive artifacts, SDK examples, proof circuit sketches, attestation formats, Merkle anchoring examples, test vectors, benchmark summaries, and IDS cross-references supporting enablement and examiner review.

### Proof Circuit Sketches

### Selective Disclosure Circuit

Public inputs: commitment_root
Private inputs: attribute preimages
Constraints: Merkle inclusion+attribute predicate checks
Output: boolean proof_valid
   IPS Fusion zkSNARK Circuit
Public inputs: canonical_ppt_digest
Private inputs: CPV, HIV, fusion_weights
Constraints: Mixture-of-Experts fusion+digest equality

### Settlement Finality Circuit

Public inputs: settlement_tx_id, merkle_root
Private inputs: escrow transitions
Output: release_authorization_flag

### Attestation and TEE Formats

### TEE Attestation JSON Schema:

```
{
  “attestation_id”: “tee_x”,
  “enclave_measurement”: “0x...”,
  “ips_token_digest”: “0x...”,
  “timestamp”: “YYYY-MM-DDThh:mm:ssZ”,
  “signer_pubkey”: “0x...”
}
```

### Attestation Binding Rule:

The attestation must include ips_token_digest and a signed enclave measurement. The verifier checks signature validity and measurement against a whitelist.

### Merkle Anchoring Examples and Test Vectors

Merkle Leaf Rule: Lᵢ=SHA256(serialized_PPTᵢ)

### Inclusion Proof Test Vector:

leaf=0xabc123 . . .
proof_path=[0xdef456 . . . , 0x789abc . . . ]
expected_root=0xdeadbeef . . .

### Anchoring Transaction Example

```
{
  “merkle_root”: “0xdeadbeef...”,
  “batch_size”: 128,
  “anchoring_ref”: “ledger_tx_98234”
}
```

### SDK and API Examples

### Provenance API

GET/v1/provenance/{ppt_digest}→

```
{
  “ppt_digest”: “...”,
  “anchoring_ref”: “...”,
  “verifier_receipts”: [...],
  “consent_state”: “active”
}
¶0080 IPS Issuance SDK Call
issueIPS(token_metadata, proof_ref, consent_token) →
{
  “ips_token_digest”: “0x...”,
  “signature”: “0x...”,
  “timestamp”: “ ...”
}
¶0081 Verifier API
POST /v1/verifyProof
{
  “receipt_id”: “...”,
  “result”: “valid”,
  “checked_leaves”: [...],
  “timestamp”: “...”
}
```

### Proof Aggregation and Aggregator Test Vectors

### OR Aggregation Example

aggregated_proof=OR_AGG(p1, p2)

### Robust Aggregator Test Vector:

Input scores: [0.9, 0.02, 0.88, 0.87]
Trimmed mean (10%): 0.883

### Attestation and Revocation Flows

### Consent Revocation Flow:

1. Revoke consent token
2. Add token_id to blocklist
3. Reissue sanitized PPT with commitments replacing revoked fields
4. Publish revocation_receipt

### Revocation Receipt Schema:

```
{
  “revocation_id”: “rev_001”,
  “token_id”: “consent_001”,
  “timestamp”: “...”,
  “issuer_signature”: “0x...”
}
```

### IDS Cross-References

### IDS Table Includes One-Line Entries for Each Cited Reference, Including:

US 2004/0133469 A1
US 2021/0318794 A1
US 2023/0261872 A1
U.S. Pat. No. 11,157,598 B2
US 2020/0402031 A1
US 2024/0223388 A1
US 2019/0236563 A1
US 2009/0083788 A1

Copies of each reference must be included in the IDS submission per 37 C.F.R. § 1.97/1.98.

### Benchmark Summaries

### Proof Verification Throughput:

Baseline verifier: 120 proofs/sec
zkSNARK verifier: 45 proofs/sec
Merkle anchoring latency: 1.2s per batch

### RL Pricing Convergence:

Episodes to convergence: ˜12,000
Reward curve stabilizes after ˜9,000 episodes

### Formal Artifacts and Examiner Aids

### Proof Registry Schema:

```
{
  “proof_id”: “...”,
  “type”: “...”,
  “merkle_root”: “...”,
  “aggregation_type”: “...”,
  “timestamp”: “...”,
  “verifier_id”: “...”
}
```

### Canonical Serialization Note:

All canonical JSON examples use RFC8785 ordering and UTF-8 encoding.

Include one canonicalized PPT JSON and its SHA-256 digest computation in the filing PDF.

1. A computer-implemented system comprising one or more processors and non-transitory memory storing instructions that, when executed, perform proof-conditioned monetization and defensive market orchestration, the system comprising:
a predictive scoring pillar configured to ingest timestamped interaction events and produce cyclical engagement vectors and time-decayed Hits History vectors;
a fusion engine configured to fuse said vectors to produce an Importance Prediction Score (IPS) and to emit an IPS token;
a Proof Registry configured to accept verifiable proofs and indexed proof descriptors and to compute composite_verification_records by normalizing proof confidences and applying market weight profiles;
an Adaptive Settlement Engine configured to, upon satisfaction of a composite_verification_record market threshold, prepare a settlement_intent, coordinate participant acknowledgements, execute an atomic commit across one or more settlement rails, and issue a cryptographically signed settlement_finality_proof; and
a Rotation Gateway configured to enforce machine-state changes for assets based on IPS thresholds and to record state changes in a tamper-evident ledger;
wherein monetization or value transfer for the IPS token is permitted only upon recording the composite_verification_record and issuance of the settlement_finality_proof.

2. The system of claim 1, further comprising an indexed proof descriptor module that stores for each proof at least: proof type, issuer_id, issuance_time, confidence_value, jurisdiction, disclosure_descriptor, and merkle_leaf_pointer.

3. The system of claim 1, wherein the Proof Registry accepts proof families selected from zero-knowledge proofs, TEE attestations, MPC outputs, homomorphic attestations, oracle attestations, and regulator receipts, and exposes APIs that return verifier_receipts comprising receipt_id, proof id, verifier_id, timestamp, result, and merkle_proof.

4. The system of claim 1, wherein the IPS token is canonicalized by serializing fields in a fixed order and computing a provenance_digest=SHA256(canonical_bytes), and wherein the canonical field order comprises: ips_token_id, timestamp, issuer id, ips_value, viewability_score, dwell_time_ms, rotation_group, confidence_interval, freshness_score, and market_metadata.

5. The system of claim 1, wherein the Rotation Gateway issues a signed state envelope comprising EGID, asset_id, old_state, new_state, timestamp, nonce, state_digest, issuer_pubkey, and signature, and requires quorum acknowledgements prior to commit and cross-network propagation.

6. The system of claim 1, wherein the Adaptive Settlement Engine records a settlement_finality_proof containing settlement id, provenance_digest, composite_verification_score, participants, finality_signature, and timestamp, and publishes the settlement_finality_proof to the Proof Registry and to one or more ledgers.

7. The system of claim 1, further comprising a MicroMarket Generator configured to instantiate markets with configurable proof requirements, aggregation weight profiles, rotation policies, and settlement rules tied to composite_verification_scores and IPS freshness.

8. The system of claim 1, wherein selective disclosure is supported by disclosure_descriptors and the system issues selective disclosure proofs enabling auditor replay without transmitting raw personal data, and wherein consent tokens gate inclusion of sensitive biological or biometric fields in IPS fusion.

9. The system of claim 1, wherein consent revocation triggers reissuance of a sanitized provenance token that omits or replaces revoked fields with cryptographic commitments and publishes a signed revocation_receipt in the Proof Registry.

10. The system of claim 1, wherein Merkle anchoring is used to batch provenance_digests into leaves Lᵢ=SHA256(serialized_provenance_tokenᵢ), compute a Merkle root R, and publish R in a ledger transaction returning an anchoring_ref.

11. The system of claim 1, wherein sensitive computations execute within a Trusted Execution Environment that produces an attestation token comprising enclave_measurement, ips_token_digest, report_binding, signer pubkey, timestamp, and signature, and wherein the attestation token is recorded in the Proof Registry.

12. The system of claim 1, further comprising an Adversarial Robustness Pipeline that performs adversarial testing, anomaly detection, verifier reputation scoring, staking and slashing rules, and automated quarantine workflows that suspend suspect tokens pending human-in-the-loop review.

13. The system of claim 1, wherein the Adaptive Settlement Engine implements deterministic insurance trigger logic:
if SLA_breach_receipt==true and composite_verification_score<market_threshold, then invoke arbitration_agent;
and if arbitration_agent.outcome==“payout,” then release funds from an insurance_pool and record a payout_receipt in the Proof Registry.

14. The system of claim 1, further comprising a discovery and matching engine that ranks assets using composite_verification_scores, IPS freshness, and reputation, and exposes ranked results to marketplace orchestration modules.

15. The system of claim 1, wherein rotation policies include rotation_group identifiers, rotation_count, cooldown_period, and cross-network synchronization by propagating Merkle-anchored proofs to partner ledgers to prevent circumvention.

16. The system of claim 1, wherein the Proof Registry normalizes raw confidence values rᵢ to cᵢ=(rᵢ−r_min)/(r_max−r_min), applies market weights wᵢ summing to 1, optionally trims outliers p %, and computes composite_verification_score C=Σᵢ wᵢ·cᵢ.

17. The system of claim 1, wherein the platform exposes regulator APIs that return selective disclosures, verifier_receipts, and Merkle proof paths, and logs each auditor query as a tamper-evident artifact.

18. The system of claim 1, further comprising developer tooling, simulation sandboxes, certification harnesses, and badge-minting modules that produce regulator-facing certification badges and replayable logs, and wherein certification badges are revocable and recorded in the Proof Registry.

19. The system of claim 1, wherein optional embodiments include quantum-assisted IPS fusion and neuromorphic ingestion modules, and wherein classical fallback fusion operators and parameter ranges are disclosed and used when quantum or neuromorphic resources are unavailable.

20. A non-transitory computer-readable medium storing instructions that, when executed by one or more processors, cause the processors to perform the operations of any one of claims 1-19, including minting IPS tokens, publishing proofs to the Proof Registry, invoking the Rotation Gateway, and executing settlement orchestration conditioned on composite_verification_records and settlement_finality_proofs.
